(19) United States
(12) Patent Application Publication
(10) Pub. No.: US 2004/0023835 A1
(43) Pub. Date: Feb. 5, 2004

(54) Fabric care composition

(76) Inventors: Robert James Chatfield, Merseyside (GB); Robert John Crawford, Merseyside (GB); Vanessa Louise Kilhams (nee Hodben), Merseyside (GB)

Correspondence Address: UNILEVER, PATENT DEPARTMENT, 45 RIVER ROAD, EDGEWATER, NJ, 07020, US

(21) Appl. No.: 10/362,279

(22) PCT Filed: Aug. 24, 2001
(86) PCT No.: PCT/EP01/09883

(30) Foreign Application Priority Data
Sep. 1, 2000 (GB) 0021483.3

(51) Int. Cl. C11D 3/37; C11D 7/42

(52) U.S. Cl. 510/475; 510/392

(57) ABSTRACT

A fabric care composition comprises a cellulase and a polymeric material which is capable of self cross-linking and/or of reacting with cellulose, wherein the polymeric material comprises one or more poly(oxyalkylene) groups having an end group which comprises one or more amino groups or derivatives of said amino groups. The compositions may be used to treat fabric as part of a laundering process and improve the surface colour definition of the fabric following multiple washings and impart pill and/or fuzz resistance to fabric during laundering.

### TECHNICAL FIELD

This invention relates to fabric care compositions and to methods of treating fabric using the compositions.

### BACKGROUND AND PRIOR ART

The laundry process generally has several benefits for fabric, the most common being to remove dirt and stains from the fabric during the wash cycle and to soften the fabric during the rinse cycle. However, there are numerous disadvantages associated with repeated use of conventional laundry treatment compositions and/or the actual laundry process; one of these being a fairly harsh treatment of fabric in the laundry process.

Fabrics can be damaged in several ways as a result of repeated laundering and/or wear. Fabric pilling and loss of fabric surface appearance e.g. fuzzing, shrinkage (or expansion), loss of colour from the fabric or running of colour on the fabric (usually termed dye transfer) are some of the common problems associated with repeated laundering. These problems may occur merely from repeated hand washing as well as the more vigorous machine washing process. Furthermore, problems relating to damage of fabric over time through normal use, such as loss of shape and increased likelihood of wrinkling are also significant.

The present invention is directed towards alleviating one or more of the problems referred to hereinabove.

The principal advantage of the present invention relates to improving the surface colour definition of a fabric after multiple washings and/or to imparting pill and/or fuzz resistance to fabric during laundering. The invention can have further advantages in the treatment of fabric. For example, other aspects of the overall appearance of the fabric can be improved, such as a reduction in the tendency of the fabric to become creased and/or wrinkled.

Laundry detergent compositions containing polyamide-polyamine fabric treatment agents are described in WO 98/29530. The compositions are claimed to impart improved overall appearance to fabrics laundered using the detergent compositions, in terms of surface appearance properties such as pill/fuzz reduction and antifading. Laundry compositions containing polyamide-polyamine treatment agents of similar types are taught in WO 97/42287. Both WO 98/29530 and WO 97/42287 mention that the compositions may contain an enzyme, such as a cellulase.

U.S. Pat. No. 5,571,286 (Connell et al) discloses certain polymers and prepolymers derived from polyoxyalkyleneamines and their use in a process for shrink-proofing wool. The treated wool may also have a softer handle than untreated wool. This document does not mention the treatment of cellulosic fabrics or the problems of loss of fabric surface appearance that they can experience following laundering. Furthermore, it deals entirely with treatment of wool on an industrial scale and does not mention the application of the compositions to fabric in the context of laundering processes.

The present invention is based on the surprising finding that certain polymeric materials, including those described in U.S. Pat. No. 5,571,286 and WO 98/29530, can impart greatly improved surface appearance to cellulosic fabrics, when used together with a cellulase.

### DEFINITION OF THE INVENTION

According to the present invention, there is provided a fabric care composition comprising a cellulase and a polymeric material which is capable of self cross-linking and/or of reacting with cellulose, wherein the polymeric material comprises one or more poly(oxyalkylene) groups having an end group which comprises one or more amino groups or derivatives of said amino groups.

The invention also provides a method of treating fabric, as part of a laundering process, which comprises applying to the fabric a fabric care composition of the invention.

Further provided by the invention in another aspect is the use of a fabric care composition of the invention to improve the surface colour definition of a fabric after multiple washings.

In another aspect, the invention provides the use of a fabric care composition of the invention to impart pill and/or fuzz resistance to fabric during laundering. In addition, the invention can impart other beneficial properties to the fabric, such as reduced creasing and/or wrinkling of the fabric during laundering.

In yet another broader aspect, the invention relates to the use of a cellulase to enhance the ability to improve the surface colour definition of a fabric after multiple washings and/or to impart pill and/or fuzz resistance to fabric during laundering of a polymer which is capable of self cross-linking and/or of reacting with cellulose. The polymer can be a polymeric material which is present in the fabric care composition or another polymer which is capable of self cross-linking and/or of reacting with cellulose.

### DETAILED DESCRIPTION OF THE INVENTION

The compositions of the present invention comprise a polymeric material which is capable of self cross-linking and/or of reacting with cellulose together with one or more textile compatible carriers, wherein the polymeric material comprises one or more poly(oxyalkylene) groups having an end group which comprises one or more amino groups or derivatives of said amino groups. The compositions also comprise a cellulase enzyme.

The compositions of the invention have the surprising advantage of imparting wear resistance to fabrics, and thereby causing improved surface colour definition of the fabric after laundering, particularly after multiple washings. Furthermore, the polymeric materials contained in the compositions need not cause unacceptable dye transfer and/or stain removal problems.

The polymeric material which can be used in the present invention can be any of the polymers or prepolymers derived from polyoxyalkyleneamines that are described in U.S. Pat. No. 5,571,286, the contents of which are incorporated herein by reference. Methods for preparing the polymeric materials are described in U.S. Pat. No. 5,571,286. Hence the polymeric material can be, for example, the reaction product of a diamine or triamine polyoxyalkylene polymer having a polymerisation degree of from 4 to 50 or a mixture thereof with epichlorohydrin in a ratio of epichlorohydrin to amino nitrogen of from 1:1 to 3:1.

The amino groups in the polymeric material of the invention may be wholly or partly in the form of derivatives of amino groups. Derivatives include, for example, adducts formed by alkylation or hydroxyalkylation at the nitrogen atom or by the formation of an amide group at the nitrogen atom. The derivatives may be formed by the reaction of the amino groups with a bifunctional bridging agent or with a cross-linking agent.

Preferably, the polymeric material is obtainable by the reaction of a polymer of formula B(R)ₙ, wherein n is from 1 to 20, B is a backbone group to which each R is covalently bonded and R is a group comprising a poly(oxyalkylene) chain, which chain comprises an amino end group, the polymer being optionally reacted with a bridging compound, with a cross-linking agent. It will thus be appreciated that the polymeric material of the invention is a relatively complex mixture comprising a number of different compounds, some or all of which may be cross-linked.

The poly(oxyalkylene) chain which forms a part of the R group may be, for example a poly(oxyethylene) or poly(oxyprop-1,2-ylene) chain. The length of the chain can vary from 2 to 100 repeat units.

Conveniently, n is 2 or 3. It will be appreciated that n may not be a whole number where the polymeric material of the invention comprises a mixture of different polymers of formula B(R)ₙ.

In some of the polymeric materials which may be used in the invention, B is

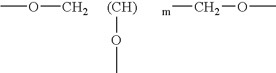

(ie, B is the residue of glycerol), n is at least 2 and m is equal to n−2.

However, B can also represent other values such as, for example, the residue of other triols or the residue of a di-, tetra-, penta- or hexa-hydroxy compound. Alternatively, B can represent the residue of a di-, tri- or poly-amine.

Preferably, at least one R group has the formula —(CH₂CH(R′)O)ₚ-P-A-NHR″, wherein R′ is H or CH₃, p is an integer from 5 to 30, A is an alkylene group and R″ is H or alkyl. More preferably, p is from 10 to 25.

The term “alkyl”, as used herein, includes C₁ to C₆ alkyl, optionally substituted on the alkyl chain, which may be branched or unbranched and, for C₃ to C₆ alkyl, may be cyclic. The term “alkylene” is defined similarly but refers to a divalent radical.

It will be appreciated that the term “end group” refers to the group at or near to the end of the poly(oxyalkylene) chain, which end, when the polymer is of formula B(R)ₙ, is at the other end of the polymer chain from the end which is attached to B.

Suitable polymers of formula B(R)ₙ include those having the following structure:

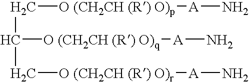

wherein R′ is as defined hereinbefore, p, q and r are integers which may be the same or different and may be from 5 to 30 and A is branched or unbranched lower alkylene.

The cross-linking agent which is used to form the polymeric material of the invention by reaction with the polymer, or the polymer after prior reaction with the bridging compound, preferably comprises an epihalohydrin. Epichlorohydrin is a suitable epihalohydrin.

Preferably the molar ratio of cross-linking agent to polymer of formula B(R)ₙ is from 0.5:1 to 4:1. Other amounts of cross-linking agent may be present in the polymeric material of the invention.

Suitable bridging compounds comprise two epoxide or carboxylic acid groups. The epoxide or carboxylic acid groups may be linked by a linker comprising alkylene, arylene, poly(oxyalkylene) or siloxane groups or combinations thereof. Examples of bridging compounds therefore include benzene-1,4-dicarboxylic acid, hexane-1,6-dicarboxylic acid and poly(oxyethylene) compounds terminated at both ends of the molecule by an epoxide group. Other suitable bridging compounds are disclosed in U.S. Pat. No. 5,571,286.

The composition of the invention can contain the polymeric material, optionally together with other polymeric materials. The compositions may further comprise a silicone which is capable of reacting with the polymeric material. Suitable reactive silicones include those having amino or hydroxyl groups which are well-known to those skilled in the art.

Preferably, the polymeric material is capable of increasing the wet strength of paper by at least 200% compared to untreated paper when applied to paper having a weight of 80 g/m² at a level of 1% solids by weight based on weight of paper, according to the test method described hereinafter.

Polymeric materials which are suitable for use in the present invention are available from Precision Processes Textiles (Ambergate, Derbyshire, UK) under the trade marks POLYMER AM and POLYMER MRSM. The polymeric materials of the invention are preferably in the form of aqueous solutions.

The compositions of the invention may comprise a textile compatible carrier. In the context of the present invention, the term “textile compatible carrier” is a component which can assist in the interaction of the first component with the fabric. The carrier can also provide benefits in addition to those provided by the first component e.g. softening, cleaning etc.

The nature of the textile compatible carrier will be dictated to a large extent by the stage at which the composition of the invention is used in a laundering process, the compositions being capable of being used, in principle, at any stage of the process. For example, where the compositions are for use as main wash detergent compositions, the one or more textile compatible carriers comprise a detergent active compound. Where the compositions are for use in the rinsing step of a laundering process, the one or more textile compatible carriers may comprise a fabric softening and/or conditioning compound or, where the compositions are for use as rinse adjuncts, the textile compatible carrier may be water.

The compositions of the invention preferably comprise a perfume, such as of the type which is conventionally used in fabric care compositions. The compositions may be packaged and labelled for use in a domestic laundering process.

The polymeric material is preferably present in the product in a sufficient quantity to give an amount of 0.0005% to 5% by weight on the fabric based on the weight of the fabric, more preferably 0.001% to 2% by weight on fabric. The amount of the polymeric material in the composition required to achieve the above % by weight on fabric will typically be in the range 0.01% to 35% by weight, preferably 0.1 to 13.5% by weight.

The polymeric materials in the compositions of the invention, when applied to a fabric, can impart benefits to the fabric when uncured. However, they may be cured by a domestic curing step including ironing and/or domestic tumble drying, preferably tumble drying. The curing is preferably carried out at a temperature in the range of from

50 to 100° C., more preferably from 80 to 100° C.

The cellulase which is present in the compositions of the invention may be a single enzyme or a mixture of enzymes. Suitable cellulases for use in laundering processes are well-known to those skilled in the art and are described in, for example, U.S. Pat. No. 4,435,307 and WO 91/17243, the contents of which are incorporated herein by reference. Cellulases may be from any origin, including bacterial and fungal sources of the enzyme. The cellulase preferably has a pH optimum in the range of pH 5 to pH 10. Examples of suitable commercially available enzymes are CAREZYME® and CELLUZYME® (available from Novo Nordisk A/S).

The cellulase is preferably present in the composition of the invention in an amount of from 0.01 mg to 5 mg of active enzyme per gram of the composition, more preferably 0.01 mg to 3 mg of active enzyme per gram of the composition. Thus, the compositions of the invention will typically comprise from 0.001% to 5%, preferably 0.01% to 1% by weight of a commercial enzyme preparation.

Surprisingly, the compositions of the invention exhibit unexpected advantages compared to otherwise identical compositions containing the polymeric material or the cellulase alone. When used to treat fabric, the cellulase and the polymeric material exhibit a synergistic effect. This result is surprising in view of the contrasting possible mechanisms of action of the cellulase and the polymeric material. Without wishing to be bound by theory, it is believed that the cellulase acts by removing the smaller fibrils from the surface of a cellulosic fabric. On the other hand, the polymeric materials may act, again without wishing to be bound by theory, by securing the fibrils to the fibres of the fabric. Therefore, it would have been surprising if the combination of cellulase and polymeric material exhibited only an additive effect but it is certainly highly surprising that the two materials exhibit a synergistic effect.

The invention, in a broader aspect, relates to the use of a cellulase to enhance the ability of a polymer which is capable of self cross-linking and/or of reacting with cellulose, to improve the surface colour definition of a fabric following multiple washings and/or to impart pill and/or fuzz resistance to fabric during laundering. In this broader aspect of the invention, the polymer may be a polymeric material which is used, or is suitable for use, in the fabric care compositions of the invention. Thus, the polymer can be any polymer which is capable of self cross-linking and/or of reacting with cellulose. The polymer may be cationic, anionic, amphoteric or neutral. Examples of suitable polymers include polyamines, such as the polyaminoamide-epichlorohydrin (or “amine- or amide-epichlorohydrin” or “PAE”) resins disclosed in WO 98/29530, the contents of which are incorporated herein by reference. Polymers of this latter type include, for example, those commercially available under the trade marks KYMENE (Hercules) and KENORES 1440 (Akzo Nobel). Examples of other suitable polymers include carbamoylsulphonate-terminated poly(ether)urethane resins of the type described in GB-A-2005322, incorporated by reference herein, and sold under the trade mark SYNTHAPPRET BAP (Bayer).

The broader aspect of the invention described hereinabove may involve any of the compositions (comprising the polymeric material or, in place of the polymeric material, another polymer which is capable of self cross-linking and/or of reacting with cellulose) and methods of the invention for treating fabric which are described herein. If the composition of the invention is to be used before, or after, the laundry process it may be in the form of a spray or foaming product.

The fabrics which may be treated in the present invention include those which comprise cellulosic fibres, preferably from 1% to 100% cellulosic fibres (more preferably 5% to 100% cellulosic fibres, most preferably 40% to 100%). The fabric may be in the form of a garment, in which case the method of the invention may represent a method of laundering a garment. When the fabric contains less than 100% cellulosic fibres, the balance comprises other fibres or blends of fibres suitable for use in garments such as polyester, for example. Preferably, the cellulosic fibres are of cotton or regenerated cellulose such as viscose.

The laundering methods (or processes) of the present invention include the large scale and small scale (eg domestic) cleaning of fabrics. Preferably, the processes are domestic.

In the method of the invention, the composition of the invention may be used at any stage of the laundering process. Preferably, the composition is used to treat the fabric in the rinse cycle of a laundering process. The rinse cycle preferably follows the treatment of the fabric with a detergent composition.

Detergent Active Compounds

If the composition of the present invention is in the form of a detergent composition, the textile-compatible carrier may be chosen from soap and non-soap anionic, cationic, nonionic, amphoteric and zwitterionic detergent active compounds, and mixtures thereof.

Many suitable detergent active compounds are available and are fully described in the literature, for example, in “Surface-Active Agents and Detergents”, Volumes I and II, by Schwartz, Perry and Berch.

The preferred textile-compatible carriers that can be used are soaps and synthetic non-soap anionic and nonionic compounds.

Anionic surfactants are well-known to those skilled in the art. Examples include alkylbenzene sulphonates, particularly linear alkylbenzene sulphonates having an alkyl chain length of C₈-C₁₅; primary and secondary alkylsulphates, particularly C₈-C₁₅ primary alkyl sulphates; alkyl ether sulphates; olefin sulphonates; alkyl xylene sulphonates; dialkyl sulphosuccinates; and fatty acid ester sulphonates. Sodium salts are generally preferred.

Nonionic surfactants that may be used include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkylpolyglycosides, glycerol monoethers, and polyhydroxyamides (glucamide).

Cationic surfactants that may be used include quaternary ammonium salts of the general formula R₁R₂R₃R₄N⁺X⁻ wherein the R groups are independently hydrocarbyl chains of C₁-C₂₂ length, typically alkyl, hydroxyalkyl or ethoxylated alkyl groups, and X is a solubilising cation (for example, compounds in which R₁ is a C₈-C₂₂ alkyl group, preferably a C₈-C₁₀ or C₁₂-C₁₄ alkyl group, R₂ is a methyl group, and R₃ and R₄, which may be the same or different, are methyl or hydroxyethyl groups); and cationic esters (for example, choline esters) and pyridinium salts.

The total quantity of detergent surfactant in the composition is suitably from 0.1 to 60 wt % e.g. 0.5-55 wt %, such as 5-50 wt %.

Preferably, the quantity of anionic surfactant (when present) is in the range of from 1 to 50% by weight of the total composition. More preferably, the quantity of anionic surfactant is in the range of from 3 to 35% by weight, e.g. 5 to 30% by weight.

Preferably, the quantity of nonionic surfactant when present is in the range of from 2 to 25% by weight, more preferably from 5 to 20% by weight.

Amphoteric surfactants may also be used, for example amine oxides or betaines.

The compositions may suitably contain from 10 to 70%, preferably from 15 to 70% by weight, of detergency builder. Preferably, the quantity of builder is in the range of from 15 to 50% by weight.

The detergent composition may contain as builder a crystalline aluminosilicate, preferably an alkali metal aluminosilicate, more preferably a sodium aluminosilicate.

The aluminosilicate may generally be incorporated in amounts of from 10 to 70% by weight (anhydrous basis), preferably from 25 to 50%. Aluminosilicates are materials having the general formula:

0.8-1.5M₂O.Al₂O₃.0.8-6SiO₂

where M is a monovalent cation, preferably sodium. These materials contain some bound water and are required to have a calcium ion exchange capacity of at least 50 mg CaO/g. The preferred sodium aluminosilicates contain 1.5-3.5 SiO₂ units in the formula above. They can be prepared readily by reaction between sodium silicate and sodium aluminate, as amply described in the literature.

Fabric Softening and/or Conditioner Compounds

If the composition of the present invention is in the form of a fabric conditioner composition, the textile-compatible carrier will be a fabric softening and/or conditioning compound (hereinafter referred to as “fabric softening compound”), which may be a cationic or nonionic compound.

The softening and/or conditioning compounds may be water insoluble quaternary ammonium compounds. The compounds may be present in amounts of up to 8% by weight (based on the total amount of the composition) in which case the compositions are considered dilute, or at levels from 8% to about 50% by weight, in which case the compositions are considered concentrates.

Compositions suitable for delivery during the rinse cycle may also be delivered to the fabric in the tumble dryer if used in a suitable form. Thus, another product form is a composition (for example, a paste) suitable for coating onto, and delivery from, a substrate e.g. a flexible sheet or sponge or a suitable dispenser during a tumble dryer cycle.

Suitable cationic fabric softening compounds are substantially water-insoluble quaternary ammonium materials comprising a single alkyl or alkenyl long chain having an average chain length greater than or equal to C₂₀ or, more preferably, compounds comprising a polar head group and two alkyl or alkenyl chains having an average chain length greater than or equal to C₁₄. Preferably the fabric softening compounds have two long chain alkyl or alkenyl chains each having an average chain length greater than or equal to C₁₆. Most preferably at least 50% of the long chain alkyl or alkenyl groups have a chain length of C₁₈ or above. It is preferred if the long chain alkyl or alkenyl groups of the fabric softening compound are predominantly linear.

Quaternary ammonium compounds having two long-chain aliphatic groups, for example, distearyldimethyl ammonium chloride and di(hardened tallow alkyl) dimethyl ammonium chloride, are widely used in commercially available rinse conditioner compositions. Other examples of these cationic compounds are to be found in “Surface-Active Agents and Detergents”, Volumes I and II, by Schwartz, Perry and Berch. Any of the conventional types of such compounds may be used in the compositions of the present invention.

The fabric softening compounds are preferably compounds that provide excellent softening, and are characterised by a chain melting Lβ to Lα transition temperature greater than 25° C., preferably greater than 35° C., most preferably greater than 45° C. This Lβ to Lα transition can be measured by DSC as defined in “Handbook of Lipid Bilayers”, D Marsh, CRC Press, Boca Raton, Fla., 1990 (pages 137 and 337). Substantially water-insoluble fabric softening compounds are defined as fabric softening compounds having a solubility of less than 1×10⁻³ wt % in demineralised water at 20° C. Preferably the fabric softening compounds have a solubility of less than 1×10⁻⁴ wt %, more preferably less than 1×10⁻⁸ to 1×10⁻⁶ wt %.

Especially preferred are cationic fabric softening compounds that are water-insoluble quaternary ammonium materials having two C₁₂₋₂₂ alkyl or alkenyl groups connected to the molecule via at least one ester link, preferably two ester links. An especially preferred ester-linked quaternary ammonium material can be represented by the formula II:

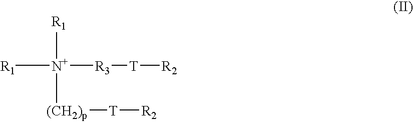

wherein each R₁ group is independently selected from C₁₋₄ alkyl or hydroxyalkyl groups or C₂₋₄ alkenyl groups; each R₂ group is independently selected from C₈₋₂₈ alkyl or alkenyl groups; and wherein R₃ is a linear or branched alkylene group of 1 to 5 carbon atoms, T is

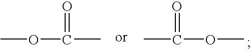

and p is 0 or is an integer from 1 to 5.

Di(tallowoxyloxyethyl) dimethyl ammonium chloride and/or its hardened tallow analogue is especially preferred of the compounds of formula (II).

A second preferred type of quaternary ammonium material can be represented by the formula (III):

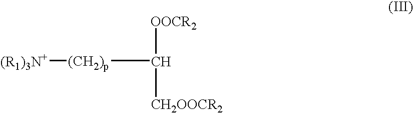

wherein R₁, p and R₂ are as defined above.

It is advantageous if the quaternary ammonium material is biologically biodegradable.

Preferred materials of this class such as 1,2-bis(hardened tallowoyloxy)-3-trimethylammonium propane chloride and their methods of preparation are, for example, described in U.S. Pat. No. 4,137,180 (Lever Brothers Co). Preferably these materials comprise small amounts of the corresponding monoester as described in U.S. Pat. No. 4,137,180, for example, 1-hardened tallowoyloxy-2-hydroxy-3-trimethylammonium propane chloride.

Other useful cationic softening agents are alkyl pyridinium salts and substituted imidazoline species. Also useful are primary, secondary and tertiary amines and the condensation products of fatty acids with alkylpolyamines.

The compositions may alternatively or additionally contain water-soluble cationic fabric softeners, as described in GB 2 039 556B (Unilever).

The compositions may comprise a cationic fabric softening compound and an oil, for example as disclosed in EP-A-0829531.

The compositions may alternatively or additionally contain nonionic fabric softening agents such as lanolin and derivatives thereof.

Lecithins are also suitable softening compounds.

Nonionic softeners include Lβ phase forming sugar esters (as described in M Hato et al Langmuir 12, 1659, 1666, (1996)) and related materials such as glycerol monostearate or sorbitan esters. Often these materials are used in conjunction with cationic materials to assist deposition (see, for example, GB 2 202 244). Silicones are used in a similar way as a co-softener with a cationic softener in rinse treatments (see, for example, GB 1 549 180).

The compositions may also suitably contain a nonionic stabilising agent. Suitable nonionic stabilising agents are linear C₈ to C₂₂ alcohols alkoxylated with 10 to 20 moles of alkylene oxide, C₁₀ to C₂₀ alcohols, or mixtures thereof. Advantageously the nonionic stabilising agent is a linear C₈ to C₂₂ alcohol alkoxylated with 10 to 20 moles of alkylene oxide. Preferably, the level of nonionic stabiliser is within the range from 0.1 to 10% by weight, more preferably from 0.5 to 5% by weight, most preferably from 1 to 4% by weight. The mole ratio of the quaternary ammonium compound and/or other cationic softening agent to the nonionic stabilising agent is suitably within the range from 40:1 to about 1:1, preferably within the range from 18:1 to about 3:1.

The composition can also contain fatty acids, for example C₈ to C₂₄ alkyl or alkenyl monocarboxylic acids or polymers thereof. Preferably saturated fatty acids are used, in particular, hardened tallow C₁₆ to C₁₈ fatty acids. Preferably the fatty acid is non-saponified, more preferably the fatty acid is free, for example oleic acid, lauric acid or tallow fatty acid. The level of fatty acid material is preferably more than 0.1% by weight, more preferably more than 0.2% by weight. Concentrated compositions may comprise from 0.5 to 20% by weight of fatty acid, more preferably 1% to 10% by weight. The weight ratio of quaternary ammonium material or other cationic softening agent to fatty acid material is preferably from 10:1 to 1:10.

The fabric conditioning compositions may include silicones, such as predominately linear polydialkylsiloxanes, e.g. polydimethylsiloxanes or aminosilicones containing amine-functionalised side chains; soil release polymers such as block copolymers of polyethylene oxide and terephthalate; amphoteric surfactants; smectite type inorganic clays; zwitterionic quaternary ammonium compounds; and nonionic surfactants.

The fabric conditioning compositions may also include an agent which produces a pearlescent appearance, e.g. an organic pearlising compound such as ethylene glycol distearate, or inorganic pearlising pigments such as microfine mica or titanium dioxide (TiO₂) coated mica.

The fabric conditioning compositions may be in the form of emulsions or emulsion precursors thereof.

Other optional ingredients include emulsifiers, electrolytes (for example, sodium chloride or calcium chloride) preferably in the range from 0.01 to 5% by weight, pH buffering agents, and perfumes (preferably from 0.1 to 5% by weight).

Further optional ingredients include non-aqueous solvents, perfume carriers, fluorescers, colourants, hydrotropes, antifoaming agents, antiredeposition agents, enzymes, optical brightening agents, opacifiers, dye transfer inhibitors, anti-shrinking agents, anti-wrinkle agents, anti-spotting agents, germicides, fungicides, anti-oxidants, UV absorbers (sunscreens), heavy metal sequestrants, chlorine scavengers, dye fixatives, anti-corrosion agents, drape imparting agents, antistatic agents and ironing aids. This list is not intended to be exhaustive.

Fabric Treatment Products

The composition of the invention may be in the form of a liquid, solid (e.g. powder or tablet), a gel or paste, spray, stick or a foam or mousse. Examples including a soaking product, a rinse treatment (e.g. conditioner or finisher) or a mainwash product. The composition may also be applied to a substrate e.g. a flexible sheet or used in a dispenser which can be used in the wash cycle, rinse cycle or during the dryer cycle.

The invention will now be described by way of example only and with reference to the following non-limiting examples.

### EXAMPLES

POLYMER AM (trade mark) and POLYMER MRSM (trade mark) are polymeric materials according to the invention and were obtained from Precision Processes Textiles of Ambergate, Derbyshire, UK.

Test Method for Assessing Wet-Strength Resins on Paper by Tensile Strength

The test procedure used was as follows:

Paper selected=80 gsm White Copier Bond, 210×297 mm, Universal Office Supplies ref UCOP80. Dry weight of one A4 sheet=4.91 g. Weight after 30 minute soak and removal of excess water=7.30 g. Pick-up therefore set as 50%.

For the untreated standard, the paper was soaked in deionised water for 10 minutes in a shallow tray. After this time, sheets were removed and the excess water removed by gently patting with paper towels until all surface water had been removed. The paper was then dried at 110° C. for 10 minutes in a fan-assisted oven.

For the treated sample, a solution of Polymer AM or Polymer MRSM (trade mark) with water was prepared along with 2 g/l of sodium bicarbonate to provide an application level by pick-up of 1% o.w.f.

As with the reference, the treated samples are soaked for 10 minutes in the solution, the excess water removed and then dried/cured as above.

The paper is then allowed to stand for at least 24 hours (as the tensile strength measurements are carried out on saturated paper, it is not necessary to condition the paper at 65% RH).

The samples are cut using a guillotine to 270 mm by 67 mm, and lines are drawn parallel to the smaller length 35 mm in to act as a guide when clamping the sample into the Testometric jaws.

The samples are then soaked in deionised water for 30 minutes.

After this time, the majority of the water is drained away to leave the paper saturated while measurements are made. Prior to the test being performed, the excess water is removed as before.

Testometric set-up—25 kgf load cell, 100 mm/min speed, pre-tension 0.1 kgf, sample length 200 mm, sample width 67 mm.

The results of the tests were as follows:

| Sample treatment | Wet strength (kgf) |
|---|---|
| Untreated paper | 1.069 |
| Polymer AM | 4.920 |
| Polymer MRSM | 4.017 |

### Examples 1 to 3

Three items of fabric (pre-pilled blue cotton interlock (20 cm×20 cm), patterned cotton sheeting (20 cm×20 cm) and patterned pyjama suit (10 cm×10 cm)) were washed in a Linitester pot. The combined weight of cloth was 17.5 g and a 6:1 wash liquor to cloth ratio was employed (105 ml of water was added to the pot). Each pot contained ten steel balls. Washes were carried out for 30 minutes at 40° C. The washed cloths were rinsed in demineralised water and dried on the “extra dry” setting of a Miele® tumble dryer until it reached the “anti-crease” part of the program. Five wash/dry cycles were performed. The following combinations of PAE resin (Kenores 1440 (trade mark), (Akzo Nobel)) and cellulase (Carezyme 4500L (trade mark), Novo) were added to each Limitester pot before each wash.

| | PAE (% owf) | Cellulase (mg/l) |
|---|---|---|
| Control | 0 | 0 |
| Comparative Example 1 | 0.5 | 0 |
| Comparative Example 2 | 1.0 | 10 |
| Comparative Example 3 | 0 | 10 |
| Example 1 | 0.5 | 10 |
| Example 2 | 1.0 | 10 |
| Comparative Example 4 | 0 | 20 |
| Example 3 | 0.5 | 20 |

The treated fabrics (patterned cotton sheeting) were subjected to sensory evaluation by a panel of testers. The fabrics were rated by how close they appeared to new fabric. The following results, in terms of mean preference levels, were obtained:

| | Mean | PAE | Cellulase |
|---|---|---|---|
| | Preference | (% owf) | (mg/l) |
| Control | 0.0001 | 0 | 0 |
| Comparative Example 1 | 0.0214 | 0.5 | 0 |
| Comparative Example 3 | 0.0001 | 0 | 10 |
| Example 1 | 0.0830 | 1.0 | 0 |
| Comparative Example 2 | 0.0821 | 1.0 | 0 |
| Comparative Example 3 | 0.0001 | 0 | 10 |
| Example 2 | 0.4216 | 1.0 | 10 |
| Comparative Example 1 | 0.0214 | 0.5 | 0 |
| Comparative Example 4 | 0 | 0 | 20 |
| Example 3 | 0.0750 | 0.5 | 20 |

These examples clearly show that there is a synergistic effect when PAE resins are used together with cellulase in laundry compositions. There is a greater than expected improvement in the overall appearance of the fabric when PAE resins and cellulase are used together.

### Examples 4 and 5

The procedure of Examples 1 to 3 was repeated but 0.735 g of Persil Non-Biological (trade mark) washing powder was included in the wash liquor. The following results were obtained:

| | Mean | PAE | Cellulase |
|---|---|---|---|
| | Preference | (% owf) | (mg/l) |
| Comparative Example 5 | 0.0615 | 0.5 | 0 |
| Comparative Example 6 | 0 | 0 | 10 |
| Example 4 | 0.1582 | 0.5 | 10 |
| Comparative Example 7 | 0.1840 | 1.0 | 0 |
| Comparative Example 8 | 0 | 0 | 10 |
| Example 5 | 0.2150 | 1.0 | 10 |

The synergistic effect is therefore exhibited when PAE and cellulase are used together in the presence of detergent.

### Examples 6 and 7

Examples 4 and 5 were repeated without cellulase and PAE in the wash liquor. After the wash cycle, the cloths were rinsed thoroughly with demineralised water and then rinsed at 25° C. for 5 minutes (without steel balls) in 105 ml demineralised water containing PAE and 0.77 g of Regular Comfort Blue (trade mark) fabric conditioner. After the rinse cycle, the cloths were spun and dried as in Examples 1 to 3. The following results were obtained:

| | Mean | PAE | Cellulase |
|---|---|---|---|
| | Preference | (% owf) | (mg/l) |
| Comparative Example 9 | 0.0019 | 0.5 | 0 |
| Comparative Example 10 | 0.0045 | 0 | 20 |
| Example 6 | 0.0378 | 0.5 | 20 |
| Comparative Example 11 | 0.0024 | 0 | 10 |
| Example 7 | 0.0329 | 0.5 | 10 |

The synergistic effect is therefore also exhibited when PAE and cellulase are used together with fabric softener/conditioner in the rinse cycle.

### Example 8

Patterned cotton sheeting (ten 20×20 cm squares) was subjected to 15 wash/dry cycles using a Miele (trade mark) European front-loading washing machine (40° C. cycle) and a Miele (trade mark) tumble dryer (extra dry setting). PAE (Kenores 1440) and Cellulase (CAREZYME 4500 L) were included in Persil Non-biological (trade mark) detergent which was used in the normal way during the wash cycle. Each wash was carried out using demineralised water (20 litres per wash) with the load made up to 1.5 kg using white cotton sheeting. Preferences were determined as above. The results are given in the following table.

| | | | Cellulase |
|---|---|---|---|
| | Preference | PAE % owf | mg/l |
| Comparative Example 12 | 0.0000 | 0 | 0 |
| Comparative Example 13 | 0.0247 | 0.5 | 0 |
| Comparative Example 14 | 0.0003 | 0 | 0.417 |
| Example 8 | 0.9750 | 0.5 | 0.417 |

Thus PAE/cellulase synergy exists when dosed in the main wash along with detergent under real washing machine conditions.

### Example 9

Example 8 was repeated using Polymer AM instead of PAE (75 g of Polymer AM @ 10% replaces PAE)

| | | | Cellulase |
|---|---|---|---|
| | Preference | AM % owf | mg/l |
| Comparative Example 15 | 0.0004 | 0 | 0 |
| Comparative Example 16 | 0.0097 | 0.5 | 0 |
| Comparative Example 17 | 0.0024 | 0 | 0.417 |
| Example 9 | 0.9876 | 0.5 | 0.417 |

1. Fabric care composition comprising a cellulase and a polymeric material which is capable of self cross-linking and/or of reacting with cellulose, wherein the polymeric material comprises one or more poly(oxyalkylene) groups having an end group which comprises one or more amino groups or derivatives of said amino groups.

2. Composition as claimed in claim 1, wherein the polymeric material is obtainable by the reaction of a polymer of formula B(R)ₙ, wherein n is from 1 to 20, B is a backbone group to which each R is covalently bonded and R is a group comprising a poly(oxyalkylene) chain, which chain comprises an amino end group, the polymer being optionally reacted with a bridging compound, with a cross-linking agent.

3. Composition as claimed in claim 2, wherein n is 2 or 3.

4. Composition as claimed in claim 2 or claim 3, wherein n is at least 2, B is 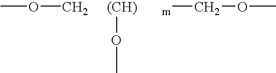
and m is equal to n−2.

5. Composition as claimed in any one of claims 2 to 4, wherein at least one R group has the formula —(CH₂CH(R′)O)ₚ-A-NHR″, wherein R′ is H or CH₃, p is an integer from 5 to 30, A is an alkylene group and R″ is H or alkyl.

6. Composition as claimed in any one of claims 2 to 5, wherein p is from 10 to 25.

7. Composition as claimed in any one of claims 2 to 6, wherein the polymer of formula B(R)ₙ is 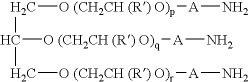
wherein p, q and r are integers which may be the same or different and may be from 5 to 30 and A is branched or unbranched lower alkylene.

8. Composition as claimed in any one of claims 2 to 7, wherein the cross-linking agent comprises an epihalohydrin.

9. Composition as claimed in any one of claims 2 to 8, wherein the molar ratio of cross-linking agent to polymer of formula B(R)ₙ is from 0.5:1 to 4:1.

10. Composition as claimed in any one of claims 2 to 9, wherein the bridging compound comprises two epoxide or carboxylic acid groups.

11. Composition as claimed in claim 10, wherein the epoxide or carboxylic acid groups are linked by a linker comprising alkylene, arylene, poly(oxyalkylene) or siloxane groups or combinations thereof.

12. Composition as claimed in any one of claims 1 to 11 further comprising a silicone which is capable of reacting with the polymeric material.

13. Composition as claimed in any one of claims 1 to 12, wherein the polymeric material is capable of increasing the wet strength of paper by at least 200% compared to untreated paper when applied to paper having a weight of 80 g/m² at a level of 1% solids by weight based on weight of paper.

14. Composition as claimed in any one of claims 1 to 13, which comprises one or more textile compatible carriers.

15. Composition as claimed in claim 14, wherein the one or more textile compatible carriers comprise a detergent active compound.

16. Composition as claimed in claim 14, wherein the one or more textile compatible carriers comprise a fabric softening and/or conditioning compound.

17. Composition as claimed in any one of claims 1 to 16, further comprising a perfume.

18. Composition as claimed in any one of claims 1 to 17, wherein the cellulase is present in an amount of from 0.01 mg to 5 mg of active enzyme per gram of the composition.

19. Composition as claimed in any one of claims 1 to 18, wherein the polymeric material is present in an amount of from 0.01% to 35% by weight of the composition.

20. A method of treating fabric, as part of a laundering process, which comprises applying to the fabric a fabric care composition according to any one of claims 1 to 19.

21. A method as claimed in claim 20, wherein the composition is applied to the fabric during a wash cycle.

22. A method as claimed in claim 20, wherein the composition is applied to the fabric during a rinse cycle.

23. Use of a fabric care composition according to any one of claims 1 to 19 to improve the surface colour definition of a fabric after multiple washings.

24. Use of a fabric care composition according to any one of claims 1 to 19 to impart pill and/or fuzz resistance to fabric during laundering.

25. Use of a cellulase to enhance the ability to improve the surface colour definition of a fabric after multiple washings and/or to impart pill and/or fuzz resistance to fabric during laundering of a polymer which is capable of self cross-linking and/or of reacting with cellulose.

26. Use as claimed in claim 25, wherein the polymer is an amine- or amide-epichlorohydrin resin or a polymeric material as defined in any one of claims 1 to 19.

27. Use as claimed in any one of claims 23 to 26, wherein the fabric comprises cellulosic fibres.
